(19) United States
(12) Patent Application Publication
(10) Pub. No.: US 2013/0197949 A1
(43) Pub. Date: Aug. 1, 2013

(54) MOBILE FOOD MANAGEMENT SYSTEM

(71) Applicants: Jeffrey D. Dermer, Los Angeles, CA (US); Kevin Behrendt, Los Angeles, CA (US); Matthew Geller, Venice, CA (US); Jeremy Murphy, Oak Park, CA (US)

(72) Inventors: Jeffrey D. Dermer, Los Angeles, CA (US); Kevin Behrendt, Los Angeles, CA (US); Matthew Geller, Venice, CA (US); Jeremy Murphy, Oak Park, CA (US)

(73) Assignee: LotMom, Inc., Los Angeles, CA (US)

(21) Appl. No.: 13/744,192

(22) Filed: Jan. 17, 2013

Related U.S. Application Data
(60) Provisional application No. 61/587,653, filed on Jan. 17, 2012.

(51) Int. Cl. G06Q 10/02; G06Q 50/12

(52) U.S. Cl. CPC G06Q 10/02; G06Q 50/12
USPC 705/5

(57) ABSTRACT

A mobile food management system includes: a controller in communication with a lot owner's user interface and one or more vendor's user interfaces; a food truck lot management application accessible through the lot owner's user interface, the food truck lot management application adapted to receive a customized rule set, the customized rule set including one or more prioritization rules associated with a food truck lot; one or more food truck lot reservation applications accessible through the one or more vendor's user interfaces, the food truck lot reservation application adapted to receive one or more reservation requests; wherein the controller is adapted to receive the customized rule set from the food truck lot management application; receive one or more reservation requests from the one or more food truck lot reservation applications; and apply the customized rule set to the one or more reservation requests to determine a booking plan.

### BACKGROUND OF THE INVENTION

The present subject matter relates generally to a mobile food management system. More specifically, the present invention relates to a mobile food management system that creates an integrated software system that empowers, enables, and creates efficiencies for at least three distinct stakeholders in the mobile-vending industry: (1) food truck lot managers; (2) mobile vendors; and (3) regulators. While the primary embodiments described herein are directed towards mobile food management, there are numerous applications in which the subject matter presented will be valuable. For example, the solutions provided herein may be applied to the management of farmer's markets—many of the advantages provided to lot managers through the system provided herein apply to managers of farmer's markets as well. Of course it will be apparent that the solutions provided herein may be applied in numerous contexts.

The system greatly improves the optimization of scarce resources for all interested parties. The system's efficiencies enable the profitable use of assets that would otherwise be uneconomical. Lot (and market) managers are able to reduce labor, monitoring, and other administrative costs with their existing operations while improving the important characteristics of their lots. Mobile vendors benefit from improved ability to reserve, pay for, and use lots, as well as manage data, communicate with current and potential customers, trade associations, and one another, as well as comply with municipal regulations. Regulators will be able to use the system to improve compliance, and do so while using fewer resources.

Managing a food truck lot is resource intensive and done under incredible uncertainty of demand. The mobile food industry is relatively new; accordingly, there is little to no historical data on which to based management decisions. Among other responsibilities, lot owners (or lessors) must vet the quality of the vendors, comply with regulations and land-use restrictions and commercial leases, ensure that customers receive access to a market-clearing variety of cuisine, and manage the operation of the lots including receipt of payment. Limited margins in lot operation and uncertainties of demand necessitate a low-cost solution to these problems. Consumer demand is difficult to forecast and the continued variation of trucks with the retention of well-performing trucks at a given location is highly beneficial. Vendors' ability to self-book lot spaces subject to lot owners' pre-set rules and restrictions will optimize and revolutionize food truck lots.

Managing a food truck is also challenging. Not only do food trucks often deal with changing locations and a transient customer base, in many instances, the food truck's menu changes as well. Given that a food truck is mobile, vendors follow a unique set of challenges and must comply with regulations wherever they travel. Food trucks suffer many inefficiencies due to the constantly changing environment in which they operate.

In certain areas, food trucks may reserve a lot in order to sell food in a desired location. Currently, reserving a lot requires a burdensome amount of interaction between the vendor trying to reserve the lot and the lot manger. This is very time consuming and inefficient to the point that it leads to lot underutilization and similar inefficiencies. Also, lots are often over or under booked, and the allocation of favorable lots may be determined by local interest (i.e., personal/political connections, etc.), completely by random, or in other non-optimal manners. Not only is this unfair, but it decreases the efficiency of all of the food trucks in that particular lot since the randomness of this reservation method often leads to less than optimal supply of foods on the food trucks as well as a less than optimal grouping of food trucks in a given location.

Unlike a restaurant, which has a fixed location, mobile cuisine customers may not know how to find a food truck on any given day, and it may be difficult for customers to contact the food truck and track their location. Many food trucks also have menus that change often since they may serve a different clientele in different locations. Customers may find it difficult to know where the food truck may be at a particular time, and what food they may be supplying. Also, unlike restaurants, food trucks may not be capable of supporting online orders, which are increasingly popular and desired among many customers.

Due to their mobile nature, food trucks may benefit from a system that allows them to compile sales data and optimize menus for every location. Collecting, organizing, and analyzing data generated in this manner may help mobile vendors and their trade associations optimize routes, pricing, menus, and food quantity under various conditions. Food truck operators will benefit greatly from the ability to self-book lots, once approved, in advance. The automated lot booking will make advertising and marketing easier and more easily automated as well.

Regulatory authorities face similar issues. Charged with the responsibility of tracking, monitoring, and inspecting mobile food facilities has proven to be a difficult, if not an impossible and costly, endeavor for local governments. Real-time information is required to appropriately manage these responsibilities. A real-time networked interface is the only manner in which regulators will be able to meaningfully monitor compliance with applicable health and public safety standards.

Accordingly, a need exists for a real-time networked mobile food management system that improves the efficiency with which mobile food vendors reserve lots, manage data, communicate with each other, current and potential customers, communicate with trade associations, and comply with municipal regulations, as described and claimed herein.

### BRIEF SUMMARY OF THE INVENTION

The mobile food management system provided herein improves the efficiency with which mobile food vendors reserve lots, manage data, communicate with current and potential customers, communicate with trade associations, and comply with municipal regulations.

Through the mobile food management system provided herein, vendors may reserve lots using an online interface that facilitates the reservation process, making it quicker and easier and with less interaction between the mobile food supplier and the lot manager. Mobile food suppliers may view information about available lots and reserve lots using an online shopping cart. As a result, the proportions of vendors dealing in a particular cuisine may be monitored and controlled, thereby improving the allocation of selling opportunities and improving the mix of vendors in a particular location. The system may also offer lots at a market-clearing price so that the price of the lots may be calibrated and made available to mobile food suppliers on a real-time basis. The market-clearing price may be determined based on the demand for that particular lot and the supply of spaces available in the lot. Pre-approval of vendors, and self-booking of lots will greatly reduce operating costs, as well as improve the accuracy and transmission speed of important data.

The mobile food management system may also allow the mobile food vendor to collect, organize, and analyze data generated in the course of their business. Since the mobile food vendors are constantly changing their locations and cuisines, the mobile food management system is provided to allow them to optimize their schedules so that they may successfully run their business. Collecting, organizing, and analyzing the data generated in this manner may help mobile vendors and their trade associations optimize routes, pricing, and menus under various conditions. Vendors may use this information to decide whether to add a particular lot to their route, and lot managers may use this information to determine the composition and reservation rates of the lot. As provided above, the mobile food vendors may include food trucks, farmer's markets, or any other supplier of food that may change locations frequently or may only exist temporarily (e.g., pop-up restaurants).

The mobile food management system may also facilitate communication between mobile food customers by using social networks to inform customers of their location and current menu for any given day. This allows mobile food vendors and customers to be in constant communication. Open and constant communication is particularly useful since mobile food vendors possess a special cachet among social media friendly young customers and within other tech savvy Internet-based social networks. The mobile food management system may also support an Internet-based order processing system to facilitate the sale of food, as well as, a “crowd-sourcing” demand measurement component, through which potential customers of a food truck may express their demand for the food truck in hopes of calling the food truck to a certain location. For example, in one embodiment, potential customers may place a conditional food order and, if enough conditional orders are received within a particular geographic range (measured objectively or relatively), the food truck may be called to the location.

The mobile food management system may also facilitate communication between mobile food vendors and their trade association. Because the typical mobile food vendor has minimal capital backing, mobile food vendors rely heavily on their trade association for information and lobbying. The mobile food management system may also facilitate communication between vendors and their trade association by supporting Internet-based forums and “wiki” pages maintained by the trade association. The system may also support an Internet-based order processing system to facilitate the payment of association fees and/or lot reservation fees, as described further herein.

Finally, the mobile food management system may also promote compliance with municipal regulations and enhance the ability of regulators to monitor such compliances. Mobile food vendors, due to both their mobility and their status as food vendors, are subject to overlapping regulations from state, county, and city governments. Of particular importance, mobile food vendors must comply with the health code(s) applicable to the areas they serve. Compliance includes record keeping and conducting various aspects of the operation in the manner prescribed by health code regulations. The mobile food management system supports a platform that keeps vendors apprised of applicable regulations, facilitates online organization and filing of regulatory documents, and allows vendors and/or regulators to remotely monitor whether specific trucks are operating in accordance with applicable regulations.

Regulators are able to monitor location, route, time elapsed, taxable revenue, document/permit existence and validity in real time. GPS monitoring devices may be coupled with the management system. Notifications regarding expirations, renewals, dues, and taxes will be generated and communicated to trucks, lot owners, and regulators.

In one example, a mobile food management system includes: a controller in communication with a lot owner's user interface and one or more vendor's user interfaces; a food truck lot booking application accessible through the lot owner's user interface, the food truck lot booking application adapted to receive a customized rule set from the lot owner's user interface, the customized rule set including one or more prioritization rules associated with a food truck lot; and one or more food truck lot reservation applications accessible through the one or more vendor's user interfaces, the food truck lot reservation application adapted to receive one or more reservation requests from the one or more vendor's user interfaces; wherein the controller is adapted to receive the customized rule set from the food truck lot booking application; receive one or more reservation requests from the one or more food truck lot reservation applications; and apply the customized rule set to the one or more reservation requests to determine a booking plan.

The controller may be adapted to communicate the booking plan to the food truck lot management application, to the one or more food truck lot reservation applications, and/or through one or more social media platforms.

The mobile food management system may further include a payment module through which payment for a booked reservation may be made.

The prioritization rules include one or more rules directed to: food type; consecutive bookings; bookings made in a given period of time; ratings (consumer and/or lot owner based); bids made in an auction format, etc. The more favorable requests may be given priority over the less favorable requests. In addition, the various rules may be interactive with varied weightings. For example, a higher bid for a lot booking may be given higher priority, but due to a conflict with an existing booking of a specific food type, the higher bid may be excluded from being booked. The prioritization rules may also apply to specific spots within a lot. The lot owner may be able to create a map or otherwise describe particular spots within a lot. Trucks may be able to choose among various spots within a lot and those spots may be able to have different prioritization rules applied to spots within the same lot. For example, the best spot in a given lot may have more restrictions placed on it such as less frequent booking, or higher consumer ratings may be required to qualify to select that spot.

While described as separate applications, it is understood that the food truck lot booking application and the one or more food truck lot reservation applications are cooperative parts of a management application.

In another example, a mobile food management system includes: a controller in communication with one or more user interfaces; a management application accessible through the one or more user interfaces, the management application adapted to receive a customized rule set from one of the user interfaces, the customized rule set including one or more prioritization rules or qualification rules; and one or more management applications accessible through the one or more vendor's user interfaces, the management applications adapted to receive one or more requests from the one or more vendor's user interfaces; wherein the controller is adapted to receive the customized rule set from the management application accessible through the one or more user interfaces; one or more management applications accessible through the one or more vendor's user interfaces; and apply the customized rule set to the one or more requests to determine a booking plan.

In one embodiment, the management application is a food truck lot booking application, the request is a reservation request, and the request is associated with a food truck lot. In another embodiment, the management application is a catering booking application, the request is a request for proposal, and the request is associated with an event.

An advantage of the mobile food management system is that it allows vendors to reserve lots in real-time.

Another advantage of the mobile food management system is that it allows mobile food vendors to collect, organize, and analyze data generated in the course of their business.

A further advantage of the mobile food management system is that it allows lot managers to offer lots priced at a market-clearing price.

Yet another advantage of the mobile food management system is that it allows mobile food vendors to be in constant, and meaningful, communication with their customers.

Another advantage of the mobile food management system is that it facilitates communication between mobile food vendors and their trade association and promotes compliance with municipal regulations.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of an example of the mobile food management system demonstrating the flow of information between the various elements of the system.

FIG. 2 is a schematic representation of the various functions that may be provided by a mobile food management system.

FIG. 3 is a flowchart illustrating an example of a method of determining a market-clearing price to rent out lots to vendors.

FIG. 4A is a flowchart illustrating an example of a method of collecting data to create a chart of food sales based on location.

FIG. 4B is an example of a chart illustrating the sales of different foods made in four different locations.

FIG. 5 is a flowchart illustrating an example of a method through which a vendor may reserve a lot.

FIG. 6 is a flowchart illustrating the method of through which a vendor may inform customers of available foods and the locations of the food truck.

FIG. 7 is a flowchart illustrating how regulatory documents, including licenses, permits, sales tracking, and compliance, may be maintained and uploaded within the system.

FIG. 8 is a schematic representation of an automated food truck lot booking system.

FIG. 9 is a schematic representation of a catering booking application.

### DETAILED DESCRIPTION OF THE INVENTION

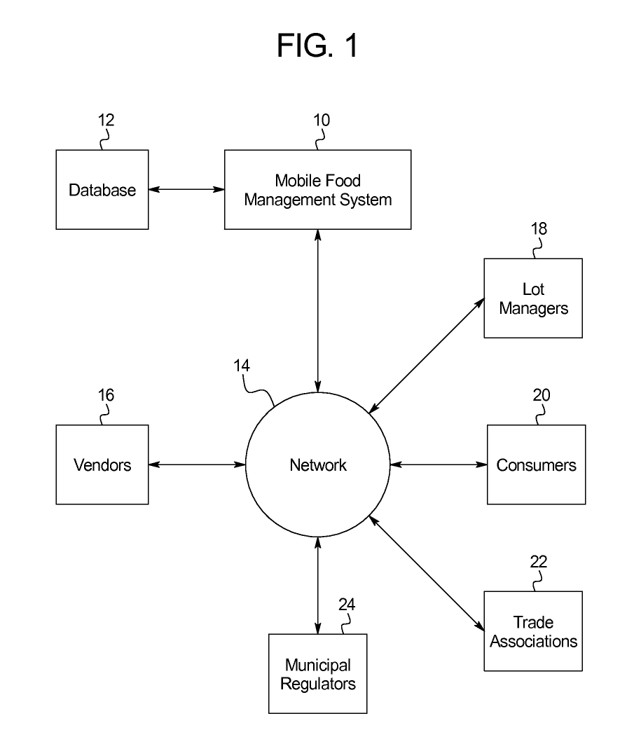

FIG. 1 illustrates an example of a mobile food management system 10 and the related elements. As shown in FIG. 1, the mobile food management system 10 may be in communication with a database 12 and a network 14. As shown, the mobile food management system 10 is in direct communication with the database 12. Of course, in other embodiments, the mobile food management system 10 may be in communication with the database through the network 14. While shown and described as a database 12, it is understood that the database 12 may be any number of databases 12 adapted to support the necessary data management to support the various features and functions of the mobile food management system 10 described herein. It is further contemplated that a database 12, as understood in the traditional sense, may not be a requirement of the mobile food management system 10 described herein, and that any other mechanism or mode of data management may be employed.

As further shown in FIG. 1, one or more vendors 16, one or more lot managers 18, one or more customers 20, one or more trade associations 22, and one or more municipal regulators 24 may interact with the mobile food management system 10 through the network 14. Communication through the network 14 enables the mobile food management system 10 to provide an interactive website and/or mobile application through which the vendors 16, lot managers 18, consumers 20, trade associations 22, and municipal regulators 24 may share information and otherwise communicate. Networked communication further enables the mobile food management system 10 to facilitate the sharing of information on social networking websites such as Facebook, Twitter, or any other social network. As is described in further detail below, the mobile food management system 10 improves the efficiency with which mobile food vendors 16 reserve lots from lot managers 18, manage data, communicate with current and potential customers 20, communicate with trade associations 22, and comply with municipal regulations 24.

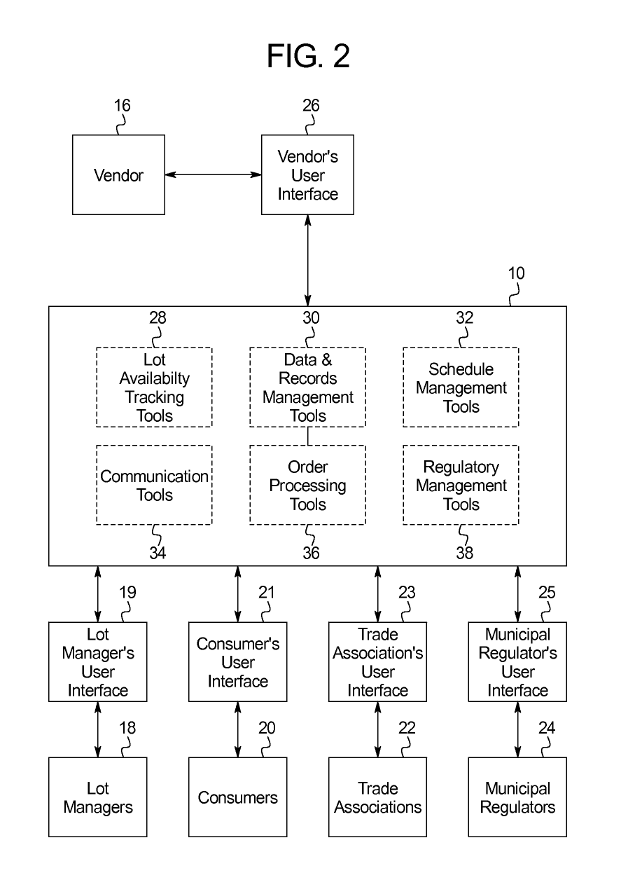

FIG. 2 illustrates the various functions that may be provided by a mobile food management system 10. For example, as shown in FIG. 2, the mobile food management system 10 may provide lot availability tracking tools 28, data and records management tools 30, scheduling management tools 32, communication tools 34, order processing tools 36, and regulatory management tools 38. While the embodiment of the mobile food management system 10 shown in FIG. 2 is the presently preferred embodiment, it is contemplated that various versions of the mobile food management system 10 may include a greater or lesser number of management tools and will be apparent to those skilled in the art based on the disclosure provided herein. It is further understood that while the various tools are expressed as independent elements within the example of the mobile food management system 10 shown in FIG. 2, such separation is provided for simplification and clarity of the description and it is known that the various tools may be overlapping, fully integrated, or otherwise interrelated, as will be understood by those skilled in the art based on the disclosures provided herein.

In the example provided in FIG. 2, a vendor 16 is shown accessing the mobile food management system 10 through a vendor's user interface 26. In the example shown, the vendor's user interface 26 may be a provided via a mobile application resident on a smartphone or similar mobile handheld computing device. However, the vendor's user interface 26 may be provided in any network-enabled device. As shown, each of the other users may access the mobile food management system 10 through corresponding user interfaces 19, 21, 23, and 25. Again, such user interfaces 19, 21, 23, and 25 may be provided in mobile applications, through one or more websites, or in any other networked application or communication protocol. For clarity and ease of description, the vendor's user interface 26 is used herein as the subject of some of the examples, though it is understood these examples are merely illustrative examples and not limiting in any way and that any of the various user interfaces may be substituted in many of the examples provided herein.

The lot availability tracking tools 28 may be used to reserve lots through an online interface 26 that facilitates booking, making booking quicker and easier with less, or no, manual interaction between the vendors 16 and the lot managers 18. The lot availability tracking tools 28 may operate in real-time, with instantaneous updates, so that vendors 16 may see only the available lots at that particular moment in time. Vendors 16 may view information about available lots and reserve lots using an online shopping cart. Using these tools, the lot booking by vendors 16 may be monitored and controlled to minimize unfair treatment and/or inefficient groupings of similar vendors 16 dealing in a particular cuisine. The lot availability tracking tools 28 may also offer tools for reserving lots at a market-clearing price so that the price of the lots may be calibrated and made available to vendors 16 on a real-time basis. The market-clearing price may be determined based on the demand for particular lots and the supply of spaces available each of in the lots.

The lot availability tracking tools 28 may enable lot managers 18 to apply automated booking rules to their reservations. For example, a lot manager 18 may only want one food truck serving a particular cuisine at one time, so if a food truck selling pizza has already been booked, another food truck selling pizza may not reserved a lot for that time slot. In another example, a lot manger 18 may only allow a vendor 16 to reserve a lot for two consecutive weeks. These examples, like others provided herein, are for illustrative purposes and it is contemplated that various booking rules may be implemented by a lot manager 18.

To monitor and assess operations, lot managers 18 may want to know how well a given vendor 16 performs and may require vendors 16 to report their sales for any given day. Lot managers 18 currently either guess at how well a vendor 16 does or uses limited tools such as paper and pencil or excel/word documents to track a vendor's 16 sales. Accordingly, the data and records management tools 30 shown in FIG. 2 may be provided to improve data management. For example, the data and records management tools 30 of the mobile food management system 10 may allow automatic sale statistics to be sent to lot managers 18, either in real-time or after a vendor 16 has compiled their records. Lot managers 18 may use this information for future reservations and pricing. Of course, the data and records management tools 30 may provide numerous tools for the access, compilation, and communication of data between the users of the mobile food management system 10.

In a further example, the data and records management tools 30 of the mobile food management system 10 may allow the mobile food vendor 16 to collect, organize, and analyze data generated in the course of their business. Since the mobile food vendors 16 are often changing their locations and cuisines, the mobile food management system 10 allows them to optimize their schedules using various schedule management tools 32, such as calendars and notification systems, so that they may successfully run their business. Using this system, vendors 16 may see when are where they are most successful, and use that information to become more profitable. This system may allow vendors 16 to track sales receipts, enabling easier taxation. Collecting, organizing, and analyzing the data generated in this manner may help mobile vendors 16 and their trade associations 22 optimize routes, pricing, and menus under various conditions. Vendors 16 may use this information in deciding whether to add a particular lot to their route, and lot managers 18 may use this information to in determining the composition and reservation rates of their lot. Mobile food vendors 16 may include food trucks, farmer's markets, or any other supplier of food that may change locations frequently.

The mobile food management system 10 may also facilitate communication between mobile food customers 20 through various communication tools 34. For example, the communication tools 34 may enable vendors 16 to use a centralized platform to communicate through associated social networks to inform customers 20 of their location and available food for any given day. This allows mobile food vendors 16 and customers 20 to be in constant communication. Open and constant communication is particularly useful since mobile food vendors 16 possess a special cachet among social media friendly young customers and within other tech savvy Internet-based social networks. Of course the provided communication tools 34 may enable communication between any of the users in various forms, such as email messaging, instant messaging, text messaging, message boards, forums, etc.

The communication tools 34 of the mobile food management system 10 may also facilitate communication between mobile food vendors 16 and their trade association 22. Since the typical mobile food vendor 16 has minimal capital backing, mobile food vendors 16 rely heavily on their trade association 22 for information and lobbying. In one example, the mobile food management system 10 may facilitate communication between vendors 16 and their trade association 22 by supporting Internet-based forums and “wiki” pages maintained by the trade association 22.

The mobile food management system 10 may also support an Internet-based order processing system 36 to facilitate the sale of food. For example, at any given time, a customer 20 may access the mobile food management system 10 and see what particular foods are available on a given food truck at a given location. For example, the customer 20 may see that there are only two chocolate cupcakes left at a particular location, and pay a fee to reserve a chocolate cupcake to be picked up at a certain time or for the chocolate cupcake to be set aside for the customer 20 for a particular amount of time. The customer 20 may then go to the food truck and pick up their chocolate cupcake. It is also possible that the vendor 16 may deliver the chocolate cupcake to the customer 20 if this option is indicated on the mobile food management system 10.

Finally as shown in FIG. 2, the mobile food management system 10 may also promote compliance with municipal regulations 38 and enhance the ability of regulators 24 to monitor such compliances through various regulatory management tools 38. Mobile food vendors 16, due to both their mobility and their status as food vendors 16, are subject to overlapping regulations 38 from state, county and city governments. Of particular importance, mobile food vendors 16 must comply with the health code(s) applicable to the areas they serve. Compliance includes record keeping and conducting various aspects of the operation in the manner prescribed by health code regulations. Accordingly, the mobile food management system 10 supports regulatory management tools 38 that keep vendors apprised of applicable regulations, facilitates online organization and filing of regulatory documents, and allows vendors 16 and/or regulators 24 to remotely monitor whether specific trucks are operating in accordance with applicable regulations. For example, regulators 24 may want to know when a vendor 16 is and is not in a commissary and/or where they vendor 16 is so that they may be inspected. The vendor 16 may possess a tracking device or location sensing device, such as an RFID (radio frequency identification) chip or a GPS (global positioning system) tracking device so that the regulator 24 may always know where they vendor 16 may be at any given time.

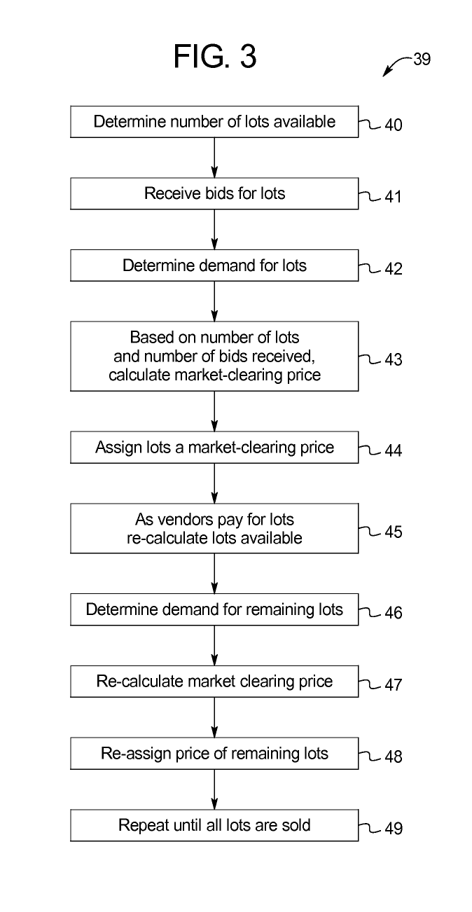

FIGS. 3-7, described in further detail below, expand on the concepts described with respect to FIG. 2 by providing additional detailed examples. It is understood that the mobile food management system 10 may be implemented to provide a wealth of tools and management services and that these examples are not limitations on the numerous uses of the mobile food management system 10.

As discussed above, vendors 16 may use the mobile food management system 10 to view information about available lots and reserve lots using an online shopping cart. The system 10 may also offer lots at a market-clearing price so that the price of the lots may be calibrated and made available to vendors 16 on a real-time basis. The market-clearing price may be determined, for example, based on the demand for that particular lot and the supply of spaces available in the lot. One example of such a method 39 is provided in FIG. 3.

The market-clearing price is the price of the goods at which the quantity supplied is equal to the quantity demanded. When the supply is high and the demand is low, a market-clearing price may be lowered to stimulate demand. For example, if there are ten lots available to be reserved for fifty dollars each, and eight lots still have not been reserved, the price may be lowered to thirty dollars per lot in order to motivate vendors. Many complex algorithms may be employed in determining market-clearing prices, though the examples used herein will be towards the simplistic side for purposes of clarity. More complex embodiments will be apparent to those having ordinary skill in the art based on the examples provided.

As shown in FIG. 3, the first step 40 of the method 39 is to determine the number of lots available. The second step 41 is to receive bids for the lots. The third step 42 is to determine the demand for the lots. The system 10 may determine the demand for the lots by counting the number of bids made for the lots, and perhaps even keep track of inquiries made about the lots. The fourth step 43 is to calculate the market-clearing price based on the number of lots and number of bids received. Once the market-clearing price has been determined, the fifth step 44 is to assign the lots a market-clearing price. The sixth step 45 is to re-calculate the market-clearing price as vendors reserve lots. The seventh step 46 is to determine the demand for the remaining lots. The eighth step 47 is to once again re-calculate the market-clearing price. The ninth step 48 is to re-assign the remaining lots with a new price, assuming the market-clearing price has changed. The tenth and final step 49 is to repeat these steps until all of the lots are sold. If there is a high demand for all of the lots and they are reserved quickly, there may be no need to re-calculate the market-clearing price if they are reserved the first time around. However, depending on the frequency of iterations in the method 39, even short of complete reservations, there may be opportunity to raise the price to reach an appropriate market-clearing price.

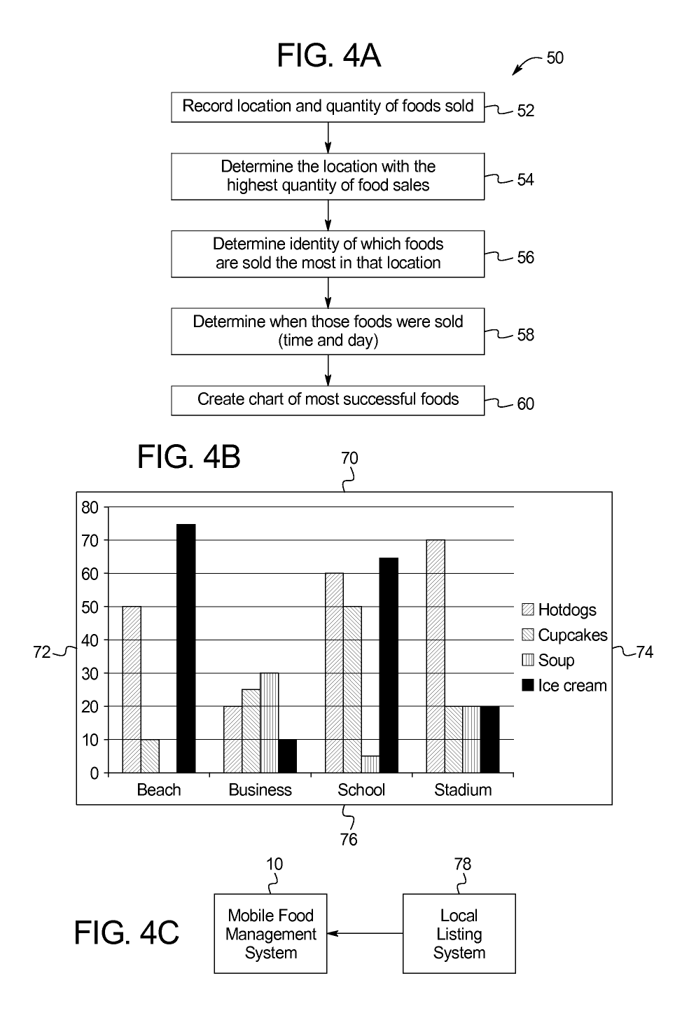

FIG. 4A-4C demonstrate how vendors 16 may use the mobile food management system 10 to analyze information to make their business more profitable. Collecting, organizing, and analyzing the data generated in this manner may help mobile vendors 16 and their trade associations 22 optimize routes, pricing, and menus under various conditions. Vendors 16 may use this information to decide whether to add a particular lot to their route, and lot managers 18 may use this information to determine the composition and reservation rates of the lot. For instance, data collected from food trucks may reveal that sales of ice cream at a beachfront lot increase 5% for every one-degree increase in temperature. Vendors 16 may use this data to ensure that they make themselves available with large amounts of ice cream at the beachfront on hot and humid days, but the greater detail provided may also influence more granular decisions.

FIG. 4A illustrates a method 50 of collecting data. In the first step 52 the mobile food management system 10 records the location and quantity of the foods that are sold. In the second step 54, the system 10 determines the location where the highest quantities of food are sold. In the third step 56, the system 10 determines which foods are sold the most in those locations. This step includes taking into account the quantity of foods sold, and the proportion of those foods sold in large quantities compared to the foods that did not sell. The system 10 may also distinguish situations where all of the different foods sold a fair amount, resulting in a high total number, and situations where only one food sold a very high amount resulting in a high total number. Vendors 16 may use these totals and proportions to determine which foods to sells at that location in the future. In the fourth step 58, the system 10 determines the time of day in which those foods are sold. This is important because certain foods may only be desirable at lunchtime, where other foods may sell at any time of day. In the fifth and final step 60, the system 10 may create a chart of the most successful foods, arranged by location. Again, while this example is simplistic for purposes of clarity, much more detailed and granular versions may be employed.

FIG. 4B is an example of a chart 70 that may be created from the data collected through the method 50 shown in FIG. 4A. The chart 70 illustrates the quantity 72 of foods 74 (hotdogs, cupcakes, soup, and ice cream) that were sold at four different locations 76 (beach, business, school, and stadium). In this particular example, a vendor 16 may conclude that ice cream is in high demand at the beach, and that the largest quantity of food 74 overall was sold at the school. In other embodiments, it is contemplated that the chart 70 may include the day in which the food 74 was sold and the time of day in which that food 74 was sold. Using this information, the vendor 16 may visit particular locations more often, or they may make more of a particular food 74 available for a location 76 that has a lot of demand. For example, when at the beach, a vendor 16 may conclude that they should provide more ice cream, and perhaps no soup or cupcakes. In other examples, vendors 16 may reach additional logical conclusions, such as certain cuisines selling only in certain areas or during particular times of day. This data may also become useful when vendors 16 are trying to determine how much food to prepare for a certain day, so that they do not have any food going to waste.

The collection and analysis of such data may be adapted to provide “heat maps” or similar outputs that identify underserved areas with unmet demand. Such outputs may provide food truck vendors 16 with better data for planning routes and lot reservations. In one example, the mobile food management system 10 may include a “local needs” module through which the mobile food management system 10 may determine what type of cuisine is lacking in the surrounding area so that the lot managers 18 can optimize offerings by booking more/less of that type of cuisine. For example, as shown in FIG. 4C, the mobile food management system 10 may determine the number of establishments within a given geographic space that serve a given type of cuisine and use that information to prioritize or rank the types of cuisines needed in that geographic space. In one embodiment, the mobile food management system 10 may interact with the API of a local listing system 78 (e.g., Yelp, CitySearch, Yahoo! Local, Google Places, etc.) to further use the local ratings for the establishments to provide even more effective analysis. For example, by considering the ratings of the establishments it may be determined that even where there may be a number of establishments serving a given type of cuisine, the ratings for those establishments are low enough that an opportunity to sell in that geographic region exists.

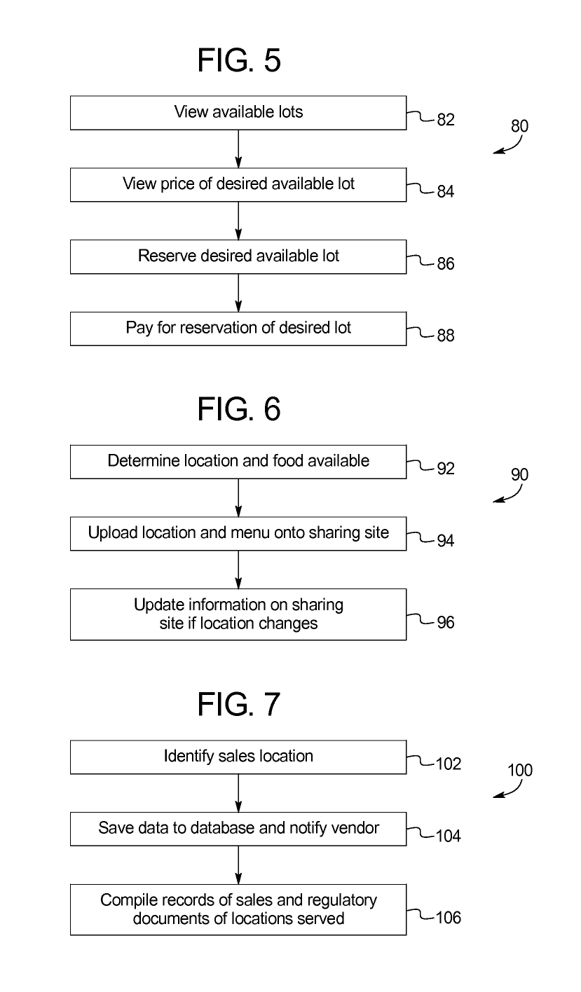

FIGS. 5-7 illustrate other functions of the mobile food management system 10. FIG. 5 illustrates the lot reservation method 80 in which a vendor 16 may reserve a lot from the lot manager 18. In the first step 82, the vendor 16 may view which lots are available. In the second step 84, the vendor may view the price of the desired available lot, or spot within the lot if the spots have been specifically described or identified on a map of the lot that the lot owner may use the mobile food management system to design and describe, which as discussed above, may be determined from the market-clearing price method 39. Alternatively or additionally, the price may include a reserve price option or ‘buy it now’ overpayment option. In the third step 86, the vendor 16 may reserve a desired lot, in which case it is removed from the list of available lots in real time, or a specific spot in a lot, which similarly would be removed from the list of available spots in a lot. In the fourth and final step 88, the vendor 16 may pay for the desired lot. Once a vendor 16 reserves a lot, it will be instantaneously removed from the list of available lots so that other vendors 16 may only view lots that have not already been reserved and paid for.

FIG. 6 illustrates the menu updating method 90 in which the vendor 16 may update a real time list of available food for customers 20. In the first step 92, the system 10 determines the location and food available at that given time. In order for this system 10 to work accurately, a vendor 16 may likely update the system 10 at the beginning of the day, since every day the menu may be different. In the second step 94, the vendor 16 may upload the location and menu on the sharing site. Once an item has been sold out, it will be removed from the menu. Once the vendor 16 changes location, the location will be changed on the schedule. If there are any other changes, such as new items or removal of a location, those changes will be made available to the website in real-time. In the third and final step 96, the information on the sharing site will be constantly updated in real-time.

FIG. 7 illustrates the method 100 in which all regulatory documents are saved to the database 12. This method 100 assures that the vendor 16 is informed about the different regulations in every location. In the first step 102, the system 10 identifies the location of the food truck. In the second step 104 the system 10 saves the data to the database and notifies the vendor 16 of all regulations. In the third and final step 106, the system 10 compiles records of sales and regulatory documents of the locations served. The method 100 insures that the vendor 16 is in compliance with all regulations and keeps record of the compliance. The records may be stored in the system 10 and on the sharing site. Since municipal regulators may also have access to the site where this information is stored, the method 100 also allows vendors 16 and/or regulators 24 to remotely monitor whether specific trucks are operating in accordance with applicable regulations.

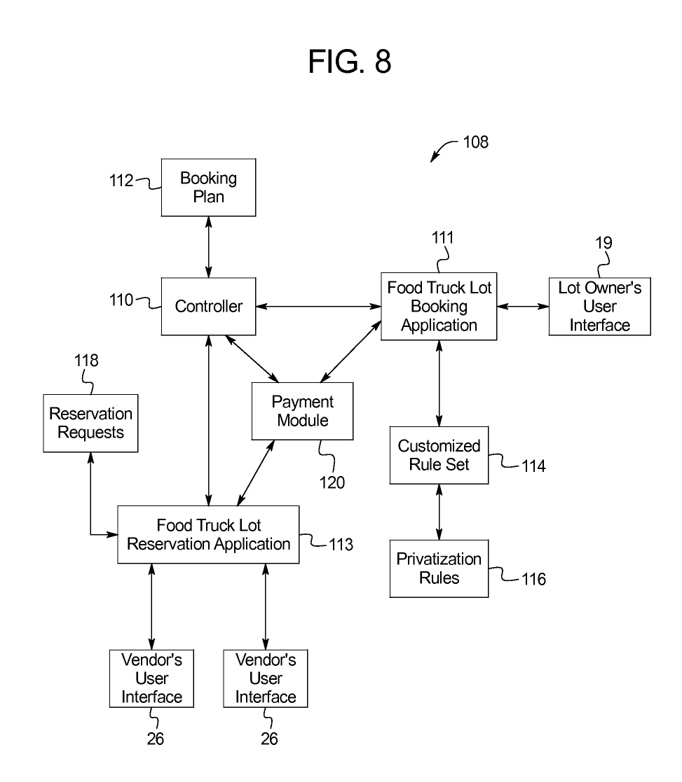

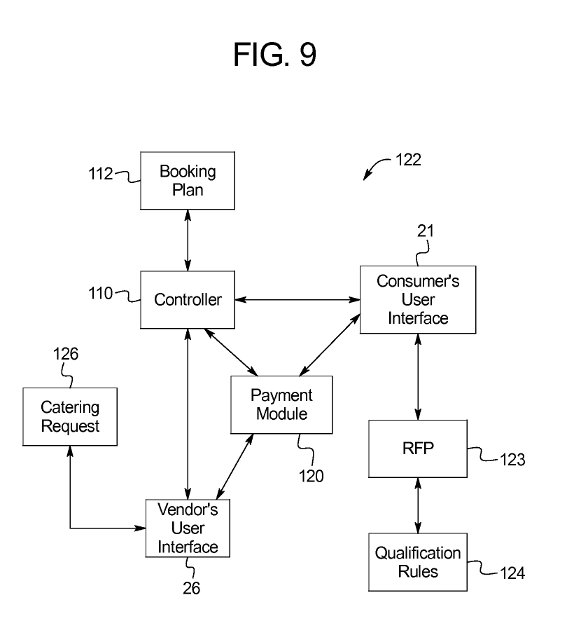

In one embodiment of the mobile food management system 10, the lot availability tracking tools 28, the data and records management tools 30, the schedule management tools 32, and the communication tools 34 are adapted to provide an automated food truck lot booking system 108. An example of an automated food truck lot booking system 108 is shown in FIG. 8.

As shown in FIG. 8, the mobile food management system 10 embodying the automated food truck lot booking system 108 includes a controller 110 that embodies the lot availability tracking tools 28, the data and records management tools 30, the schedule management tools 32, and the communication tools 34. The controller 110 is in communication with a lot owner's user interface 19 and one or more vendor's user interfaces 26, which enables the automated food truck lot booking system 108 to receive information from the lot owner's user interface 19 through a food truck lot booking application 111 and the one or more vendor's user interfaces 26 through one or more food truck lot reservation applications 113, process that information to create a booking plan 112, and to communicate the booking plan 112 back to the lot owner's user interface 19 and the one or more vendor's user interfaces 26. While described as individual applications, it is understood that the food truck lot booking application 111 and the one or more food truck lot reservation applications 113 may be cooperative parts of a single management application.

In the example shown, the information received from the lot owner's user interface 19 includes customized rule set 114. The customized rule set 114 includes one or more prioritization rules 116 associated with a specified food truck lot. The information received further includes one or more reservation requests 118 received from the one or more vendor's user interfaces 26. The controller 110 applies the customized rule set 114 to the reservation requests 118 to develop the booking plan 112.

As shown, the mobile food management system 10 receives the customized rule set 114 from the lot owner's user interface 19. In typical embodiments, the lot owner, lot manager, or other party responsible for lot bookings provides the customized rule set 114. The prioritization rules 116 are the rules by which the controller 110 processes the reservation requests 118. For example, the prioritization rules 116 may include rules related to qualifications, conflicts, etc. For example, the prioritization rules 116 may include rules related to how many food truck of a given food type may reserve lots within a given time frame. The prioritization rules 116 may include rules related to providing preferred reservations for higher rated food trucks including consumer-side ratings and/or seller-side ratings based on expected revenue, traffic generation, or other qualitative factors such as “good operator” status. The prioritization rules 116 may include rules related to the number of consecutive bookings a food truck may reserve for a given lot or how many times a food truck may reserve a place in the lot within a given time frame. The prioritization rules 116 may include rules related to a bidding/auction system in which higher bids create higher priority rankings. As can be appreciated, there are nearly limitless prioritization rules 116 that may be applied within the mobile food management system 10. The prioritization rules 116 are customizable through the lot owner's user interface 19 and enable the mobile food management system 10 to automate the lot booking process.

The prioritization rules 116 may apply not just to booking the lot as a whole, but also to specifically identifiable spots on the lot. For example, the mobile food management system 10 may receive information the lot owner's user interface 19 regarding the location of spots within a lot, a spot map, relative values of spots, expected and/or historical traffic patterns adjacent or otherwise making one spot more or less desirable, or spots adjacent to already booked/prioritized trucks. The mobile food management system 10 may allow for long-term bookings for particular lots or spots within a lot to be made on a truck-by-truck basis. In varied embodiments of the mobile food management system 10, the ability to book a spot or lot in this way may be automated or completed manually. As shown, the mobile food management system 10 may enable identification, characterization, and attribution of spots within a lot based on location, proximity to foot traffic, street visibility, expected traffic, expected value, proximity to specific trucks, proximity to specific food types, etc. These attributes may be described, for example, in text, numerically, or graphically on a customizable map that may be communicated to consumers and other trucks, whether booked or not.

The booking plan 112 that is developed may be communicated to the lot managers 18 and the vendors 16. The automated food truck lot booking system 108 may also be the platform through which the vendors 16 pay the lot managers 18 for their lot booking. Accordingly, the automated food truck lot booking system 108 may include a payment module 120 through which the transactions are confirmed and payment is settled.

Further, the booking plan 112 may be used to automate publicity/advertising related to the schedule for when the food trucks will be at a given lot. For example, the mobile food management system 10 may automatically post the booking plan 112 onto one or more social media websites, send direct communications to one or more subscribers to a feed, etc.

Turning to FIG. 9, an example is provided in which the mobile food management system 10 is adapted to provide a catering booking application 122. Through the catering booking application 122, requests can be made for food truck vendors 16 to cater an event. A lot manager 18, a consumer 20, or any other interested party (collectively “requestors”) may make a catering request through the catering booking application 122.

In one example, a request for proposal, or request for quotation, (RFP 123) may be submitted to the catering booking application 122 through a consumer's user interface 21. The RFP 123 may then be accessible to vendors 16 through their associated vendor's user interfaces 26. The catering booking application 122 may be used to screen the vendors 16 to select an appropriate vendor 16 to cater the event. Similar to the automated food truck lot booking system 108 described with respect to FIG. 8, the catering booking application 122 may enable requestors to screen potential food truck vendors 16 for a catering job through an automated process. For example, the catering booking application 122 may enable automated screening, selection, confirmation, and transaction execution based on qualification rules 124 analogous to the prioritization rules 116 of the automated food truck lot booking system 108 and catering requests 126 analogous to the reservation requests 118 of the automated food truck lot booking system 108. For example, one of the qualification rules 124 may be a number of guests to be served at the event. Another qualification rule 124 may be a price per plate or price per event rule.

The booking plan 112 and payment module 120 shown in FIG. 9 are analogous to the booking plan 112 and payment module 120 shown and described with respect to FIG. 8.

Both the food truck lot booking application 108 and the catering booking application 122 are examples of management applications that may be implemented through the mobile food management system 10. Of course it is understood that these are merely two examples of numerous management applications that may be implement based on the teachings provided herein.

As described further herein, elements of the mobile food management system 10 may be embodied in a controller 110. The controller 110 may run a variety of programs, access, and store data, including accessing and storing data in associated databases 12, as described further herein, and may further enable one or more interactions with any user interface provided. Typically, the controller 110 may be embodied in one or more programmable data processing devices. For example, the controller 110 may be a conventional microprocessor, memory (e.g., DRAM, PROM, EPROM, EEPROM, etc.), and one or more input/output interface for communications with one or more additional systems. The hardware elements, operating systems, and programming languages of such devices are conventional in nature, and it is presumed that those skilled in the art are familiar with controllers 110 of this nature.

Aspects of the mobile food management system 10 described herein encompass hardware and software for controlling the relevant functions. Software may take the form of code, or executable instructions, for causing the controller 110 or other programmable equipment to perform the relevant steps, where the code, or instructions are carried by or otherwise embodied in a medium readable by the controller 110 or other machine. Instructions or code for implementing such operations may be in the form of computer instructions of any form (e.g., source code, object code, interpreted code, etc.) stored in or carried by any readable medium. As used herein, terms such as computer or machine “readable medium” refer to any tangible medium that participates in providing instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

1. A mobile food management system comprising:
a controller in communication with a lot owner's user interface and one or more vendor's user interfaces;
a food truck lot booking application accessible through the lot owner's user interface, the food truck lot booking application adapted to receive a customized rule set from the lot owner's user interface, the customized rule set including one or more prioritization rules associated with a food truck lot; and
one or more food truck lot reservation applications accessible through the one or more vendor's user interfaces, the food truck lot reservation application adapted to receive one or more reservation requests from the one or more vendor's user interfaces;
wherein the controller is adapted to receive the customized rule set from the food truck lot booking application; receive one or more reservation requests from the one or more food truck lot reservation applications; and apply the customized rule set to the one or more reservation requests to determine a booking plan.

2. The mobile food management system of claim 1 further wherein the controller is adapted to communicate the booking plan to the food truck lot management application.

3. The mobile food management system of claim 1 further wherein the controller is adapted to communicate the booking plan to the one or more food truck lot reservation applications.

4. The mobile food management system of claim 1 wherein the controller is adapted to communicate the booking plan through one or more social media platforms.

5. The mobile food management system of claim 1 further comprising a payment module through which payment for a booked reservation may be made.

6. The mobile food management system of claim 1 wherein the prioritization rules include one or more rules directed to food type.

7. The mobile food management system of claim 1 wherein the reservation request identifies a food truck and the prioritization rules include one or more rules directed to the number of times the food truck has been included in a booking plan within a given period of time.

8. The mobile food management system of claim 1 wherein the prioritization rules include one or more rules directed to ratings.

9. The mobile food management system of claim 1 wherein the prioritization rules include one or more rules directed bids made in an auction format.

10. The mobile food management system of claim 1 wherein the food truck lot booking application and the one or more food truck lot reservation applications are cooperative parts of a management application.

11. A mobile food management system comprising:
a controller in communication with one or more user interfaces;
a management application accessible through the one or more user interfaces, the management application adapted to receive a customized rule set from one of the user interfaces, the customized rule set including one or more prioritization rules or qualification rules; and
one or more management applications accessible through the one or more vendor's user interfaces, the management applications adapted to receive one or more requests from the one or more vendor's user interfaces;
wherein the controller is adapted to receive the customized rule set from the management application accessible through the one or more user interfaces; one or more management applications accessible through the one or more vendor's user interfaces; and apply the customized rule set to the one or more requests to determine a booking plan.

12. The mobile food management system of claim 11 wherein the management application is a food truck lot booking application.

13. The mobile food management system of claim 11 wherein the management application is a catering booking application.

14. The mobile food management system of claim 11 wherein the request is a reservation request.

15. The mobile food management system of claim 14 wherein the request is associated with a food truck lot.

16. The mobile food management system of claim 15 wherein the request includes an identification of the specific lot being requested.

17. The mobile food management system of claim 11 wherein the request is a request for proposal.

18. The mobile food management system of claim 16 wherein the request associated with an event.

19. The mobile food management system of claim 11 wherein the management application is further adapted to receive information specifically identifying unique characteristics of food lots for which requests may be received.
